(19) United States
(12) Patent Application Publication
(10) Pub. No.: US 2015/0248345 A1
(43) Pub. Date: Sep. 3, 2015

(54) Swap method and Electronic System thereof

(71) Applicant: Ralink Technology Corp., Hsinchu County (TW)

(72) Inventors: Cheok Yan Goh, Hsinchu City (TW); Ching-Hwa Yu, Tainan City (TW)

(73) Assignee: Ralink Technology Corp., Hsinchu County (TW)

(21) Appl. No.: 14/194,801

(22) Filed: Mar. 2, 2014

(51) Int. Cl. G06F 12/02

(52) U.S. Cl. CPC G06F 12/02

(57) ABSTRACT

A swap method, for an electronic system, includes generating an accessing signal by a calculating module of the electronic system; generating a swap signal for instructing a swap mode of the accessing signal by the calculating module; accessing data from a storage module of the electronic system according to the accessing signal by an accessing module of the electronic system; and swapping the data according to the swap signal by a swap module.

### BACKGROUND

The present invention relates to a swap method and an electronic system thereof, and more particularly, to a swap method and an electronic system thereof capable of instructing a swap mode of an accessing signal in a corresponding swap signal.

In computing, an endian mode refers to how bytes are ordered within a single 16-bit, 32-bit or 64-bit word. In brief, the endian mode represents a byte order. An electronic module designed in big-endian stores the most significant byte first, and an electronic module designed in little-endian stores the least significant byte first. Generally speaking, calculating modules, such as CPU, and system components of an electronic system, such as a system-on-chip (SOC), may require data in different endian modes. For example, the calculating modules designed by INTEL may require data in the little endian, and the calculating modules designed by HP, IBM and MOTOROLA may require data in the big endian. Furthermore, the calculating modules may use different endian modes to access data of files with different file formats. For example, the file formats BMP, GIF, RTF adopt the little endian, and the file formats PSD (Adobe Photoshop), IMG, JPG adopt the big endian. Thus, the electronic system needs a swap mechanism for swapping data accessed for different modules. Thus, when the calculating modules and the system components require data in different endian modes, the data may need to be swapped between the different endian modes by a swap mechanism.

In the prior art, the electronic system can use special instructions, such as special instructions in a compiler of a CPU, as the swap mechanism. However, the special instructions need to be changed when the electronic system is designed on different platforms (e.g. CPU of ARMS and CPU of INTEL). In other words, designers have to manually generate the special instructions when the platform of the electronic system is changed, resulting in inconvenience and inefficiency. On the other hand, the designers can also use instructions in upper-level language, such as C code, as the swap mechanism. In comparison with the instructions of the swap mechanism designed in the compiler of the CPU, the number of instructions of the swap mechanism designed in upper-level language is significantly increased, resulting in inefficiency of the electronic system.

The swap mechanism can also be realized by hardware according to logic relationships of swapping data. For example, the designer may observe that data needs to be swapped when the data is associated to a specific file format, such that the hardware of the swap mechanism can be specified to swap the data when the data is associated to the specific file format. The hardware of the swap mechanism is fixed when the electronic system is manufactured. However, data of the same file format may need to be arranged in different endian modes under different operating conditions (ex. different protocols, different calculating modules and system components). Thus, hardware is hard to be well-defined for various operating conditions. As can be seen from the above, the prior art needs to be improved.

### SUMMARY

Therefore, the present invention provides a swap method and an electronic system thereof capable of instructing whether the data accessed according to an accessing signal needs to be swapped in a swap signal, such that the data accessed according to the accessing signal can be appropriately swapped by a swap module.

The present invention discloses a swap method, for an electronic system. The swap method includes generating an accessing signal by a calculating module of the electronic system, generating a swap signal for instructing a swap mode of the accessing signal by the calculating module; accessing data from a storage module of the electronic system according to the accessing signal by an accessing module of the electronic system, and swapping the data according to the swap signal by a swap module.

The present invention further discloses an electronic system. The electronic system includes a storing module, a calculating module, for generating an accessing signal and a swap signal instructing a swap mode of the accessing signal, an accessing module, coupled to the calculating module for accessing data from the storing module according to the accessing signal, and a swap module, for swapping the data according to the swap signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an example of the present invention.

FIG. 2 is a schematic diagram of exemplary example of related signals when the swap module shown in FIG. 1 operates.

FIG. 3 is a schematic diagram of an electronic system according to another example of the present invention.

FIG. 4 is a flow diagram of a swap method according to an example of the present invention.

### DETAILED DESCRIPTION

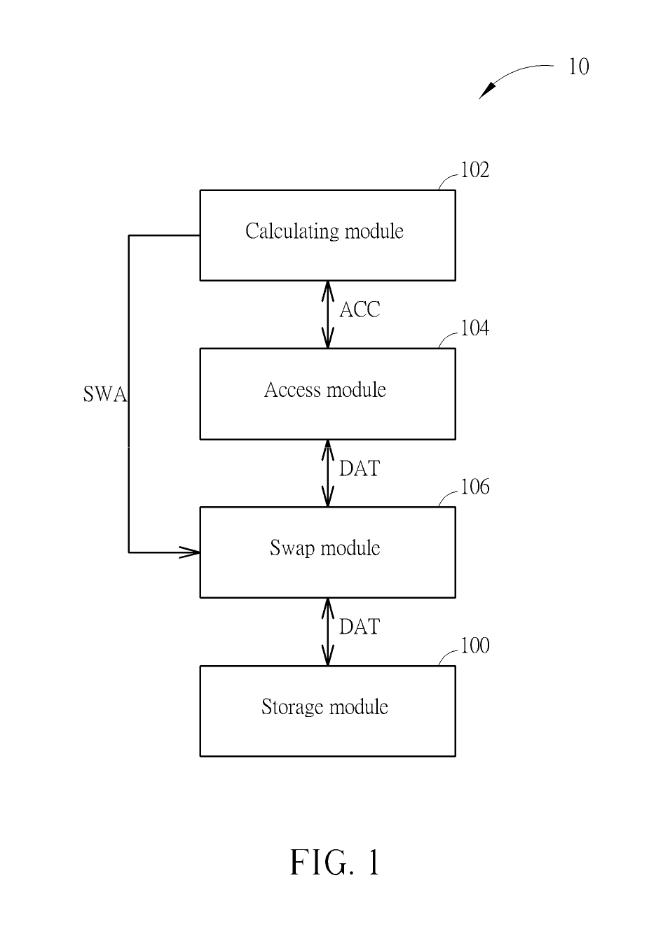

Please refer to FIG. 1, which is a schematic diagram of an electronic system 10 according to an example of the present invention. The electronic system 10 may be a system-on-chip (SoC) or an integrated circuit (IC), but is not limited herein. The electronic system 10 comprises a storage module 100, a calculating module 102, an accessing module 104 and a swap module 106. The storage module 100 may be an external memory device, such as DRAM and SRAM, but is not limited herein. The calculating module 102 is utilized for generating an accessing signal ACC and a swap signal SWA instructing a swap mode of the accessing signal ACC. In this example, the calculating module 102 can be a CPU or a direct memory access (DMA). The accessing module 104 (e.g. a bus matrix) is coupled to the calculating module 102 for accessing data DAT from the storage module 100 according to the accessing signal ACC. The swap module 106 is coupled between the accessing module 104 and the storage module 100 for swapping data DAT according to the swap signal SWA. Via the swap module 106, the calculating module 102 does not need to waste additional cycles on swapping data DAT into the appropriate endian mode and data length. Furthermore, when data of a packet required by the calculating module 102 is divided into several packet parts and each packet part needs to be swapped by different swap modes, the calculating module 102 can adaptively change the swap mode of the accessed data by simply switching the swap signal SWA. In short, the swap mode of data DAT can be appropriately changed according to the requirements of the calculating module 102 via adjusting the swap signal SWA.

In detail, when the calculating module 102 requires the data DAT, the calculating module 102 generates the accessing signal ACC with an address signal ADD for instructing the address of the data DAT stored in the storage module 100. The calculating module 102 further generates the swap signal SWA for instructing a swap mode of the accessing signal ACC. When the data DAT accessed according to the accessing signal ACC does not need to be swapped (e.g. when the endian mode of the data DAT required by the calculating module 102 is the same with that accessed from storage module 100), the swap signal SWA instructs the swap module 106 not to swap the data DAT and to directly output the data DAT to the accessing module 104. When the data DAT accessed according to the accessing signal ACC needs to be swapped (e.g. when the endian mode of the data DAT required by the calculating module 102 is different from that accessed from storage module 100), the data DAT accessed from the storage module 100 may be swapped by different data lengths (e.g. byte, half-word and word). Thus, the swap signal SWA is a 2-bit signal for instructing four swap modes (i.e. the four conditions of the data DAT does not need to be swapped and the data DAT needs to be swapped by byte, half-word and word) in this example. After instructing the swap mode corresponding to the accessing signal ACC in the swap signal SWA, the access module 104 accesses data DAT according to the address instructed in the accessing signal ACC and then the swap module 106 swaps the data DAT according to the swap signal SWA.

As a result, the data DAT is swapped to fit the requirements of the calculating module 102, such that the calculating module 102 does not need to waste clock cycles on transferring the data accessed from the storage module 100. Moreover, when data of a packet required by the calculating module 102 has a plurality of packet parts and each packet part or several parts of the packet needs to be swapped by different swap modes, the calculating module 102 can adaptively adjust the accessing signal ACC (i.e. with the address signals ADD) and the swap signal SWA for accessing data DAT corresponding to each packet part in appropriate swap mode. The operation procedures that the electronic system 10 writes the data DAT to the storage module 100 can be referred to the above, and are not narrated herein for brevity.

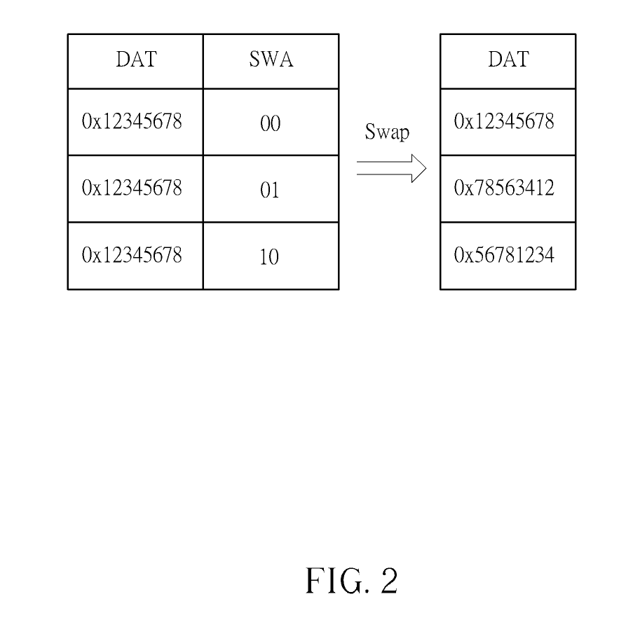

Please refer to FIG. 2, which is a schematic diagram of an exemplary example of related signals when the swap module 106 shown in FIG. 1 operates. In this example, the swap module 106 does not swap the data DAT when the swap signal SWA is ‘00’, swaps the data DAT by byte when the swap signal SWA is ‘01’, swaps the data DAT by half-word when the swap signal SWA is ‘10’ and swaps the data DAT by word when the swap signal SWA is ‘11’. As shown in FIG. 2, when the calculating module 102 writes data DAT (i.e. 0x12345678) to the storage module 100 and the swap signal SWA is ‘00’, the data DAT is not swapped by the swap module 106 and then is stored in the storage module 100. When the calculating module 102 requires data DAT from the storage module 100 and the swap signal SWA is ‘01’, the data DAT is swapped by byte (i.e. the data DAT becomes 0x78563412 from 0x12345678) and is transmitted to the access module 104. When the calculating module 102 requires data DAT from the storage module 100 and the swap signal SWA is ‘10’, the data DAT is swapped by half-word (i.e. the data DAT becomes 0x56781234 from 0x12345678) and is transmitted to the access module 104.

Please note that, in order to simplify the design of the electronic system 10, the swap signal SWA may be undefined bits of the address signal ADD of the accessing signal ACC. For example, when the address signal ADD is a 32-bit signal and the storage module 100 has 256MB to be addressed. The address signal ADD utilizes 28 bits among the 32-bit signal for addressing the 256 MB of the storage module 100. Thus, 2 bits of the undefined 4 bits among the address signal ADD can be defined as the swap signal SWA. In other examples, as long as the swap signal SWA can be corresponding to the accessing signal ACC, the swap signal SWA can also be undefined bits of other signals generated by the calculating module 102. Also, the swap signal can be extended to an N-bit signal, wherein N depends on the number of swap methods of transferring data between different endian modes.

Noticeably, the present invention instructs appropriate swap modes corresponding to the accessed data in the swap signal, such that the swap module of the electronic system swaps data according to requirements (e.g. data lengths) of the calculating module. As a result, the calculating module of the electronic system does not need to spend clock cycles on transferring accessed data, which decreases loading of the calculating module. Moreover, the swap modes of the accessed data are flexible for various operation conditions of the calculating module. The designer of the electronic system can easily switch swap modes while accessing data of different file formats, for example, via adjusting the swap signal. Compared to the swap method realized in software, the software effort of the calculating module can be reduced through adding the swap module in the electronic system. Instead of defining swap modes of data corresponding to different operation conditions in hardware, the calculating module can switch the swap mode of the swap module via adjusting the swap signal. According to different applications, those skilled in the art may accordingly observe appropriate alternations and modifications.

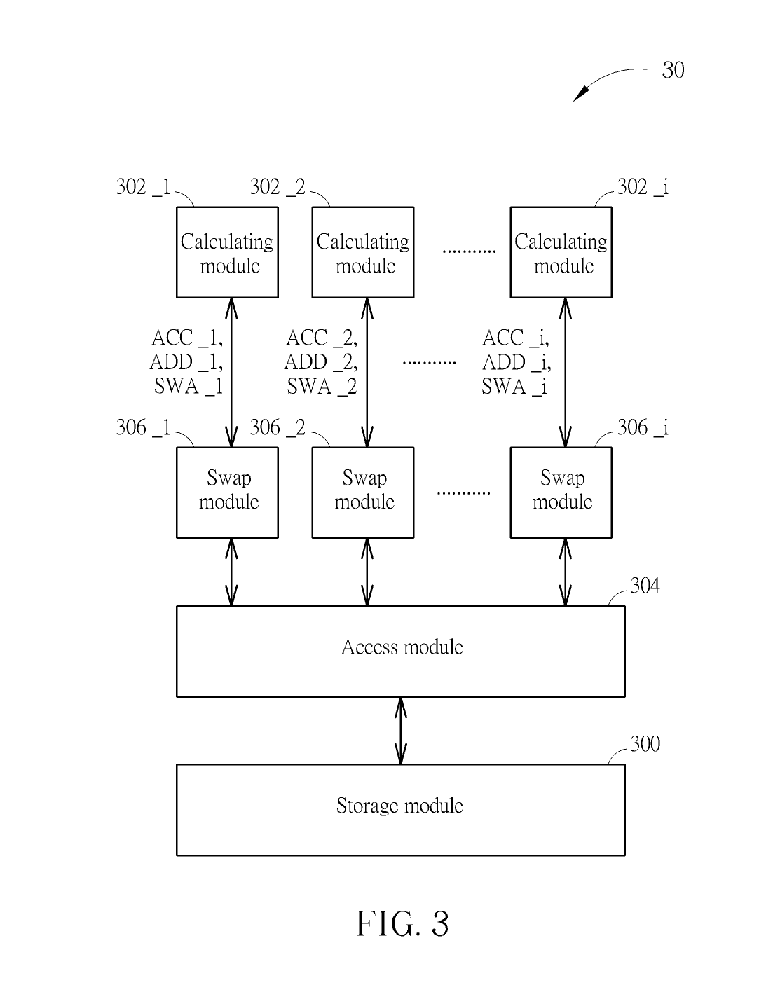

Please refer to FIG. 3, which is an electronic system 30 according to another example of the present invention. The electronic system 30 is similar to the electronic system 10 shown in FIG. 1, thus components with similar functions are represented in the same symbols. Unlike from the electronic system 10, the electronic system comprises calculating modules 302_1-302_i and swap modules 306_1-306_i. The swap modules 306_1-306_i are configured between the calculating modules 302_1-302_i and the accessing module 304. As shown in FIG. 3, the swap modules 306_1-306_i refer to swap signals SWA_1-SWA_i. The swap signals SWA_1-SWA_i can be the same. For example, the swap signals SWA_1-SWA_i may be the (m+1)-th and m-th bits of the address signals ADD_1-ADD_i of the accessing signals ACC_1-ACC_i. The swap signals SWA_1-SWA_i can also be different from each other. For example, the swap signal SWA_1 may be the (m+1)-th and m-th bits of the address signal ADD_1 of the accessing signal ACC_1. The swap signal SWA_2 may be the (n+1) -th and n-th bits of the address signal ADD_2 of the accessing signal ACC_2, and so on. Please note that, both the (m+1)-th bit and the m-th bit of the address signal ADD_1 should be undefined bits of the address signal ADD_1. Similarly, both the (n+1)-th bit and the n-th bit of the address signal ADD_2 should be undefined bits of the address signal ADD_2. As a result, data feedback to the calculating modules 302_1-302_i can be swapped in the appropriate swap modes according to the requirements of the calculating modules 302_1-302_i.

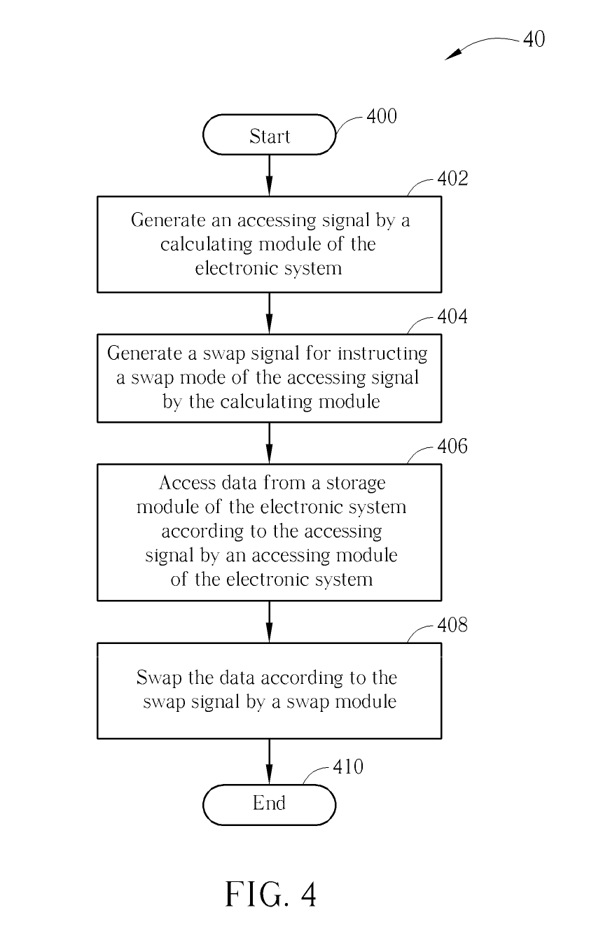

The above-mentioned process of swapping data according to the swap signal instructed by the calculating module can be summarized to a swap method 40, as shown in FIG. 4. Noticeably, the swap method 40 is not limited to the sequence shown in FIG. 4 if a same result can be obtained. Referring to FIG. 4, the swap method 40 comprises:

Step 400: Start.

Step 402: Generate an accessing signal by a calculating module of the electronic system.

Step 404: Generate a swap signal for instructing a swap mode of the accessing signal by the calculating module.

Step 406: Access data from a storage module of the electronic system according to the accessing signal by an accessing module of the electronic system.

Step 408: Swap the data according to the swap signal by a swap module.

Step 410: End.

According to the swap method 40, the accessed data can be appropriately swapped according to the requirements of the calculating module. The detailed operating procedures of the swap method 40 can be referred to the above, and are not narrated herein for brevity.

To sum up, via instructing appropriate swap modes corresponding to the accessed data in the swap signal, the swap module of the above examples swaps the accessed data according to requirements of the calculating module. As a result, the software effort of the calculating module can be reduced and the swap modes of accessed data are flexible for different system requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A swap method, for an electronic system, comprising:
generating an accessing signal by a calculating module of the electronic system;
generating a swap signal for instructing a swap mode of the accessing signal by the calculating module;
accessing data from a storage module of the electronic system according to the accessing signal by an accessing module of the electronic system; and
swapping the data according to the swap signal by a swap module.

2. The swap method of claim 1, wherein the swap signal comprises at least one undefined bit of an address signal of the accessing signal.

3. The swap method of claim 1, wherein the step of swapping the data according to the swap signal by the swap module comprises:
swapping the data according to the swap signal by the swap module while the data is transmitted between the access module and the storage module.

4. The swap method of claim 1, wherein the step of swapping the data according to the swap signal by the swap module comprises:
swapping the data according to the swap signal by the swap module while the data is transmitted between the access module and the calculating module.

5. An electronic system, comprising:
a storing module;
a calculating module, for generating an accessing signal and a swap signal instructing a swap mode of the accessing signal;
an accessing module, coupled to the calculating module for accessing data from the storing module according to the accessing signal; and
a swap module, for swapping the data according to the swap signal.

6. The electronic system of claim 5, wherein the swap signal comprises at least one undefined bit of an address signal of the accessing signal.

7. The electronic system of claim 5, wherein the swap module is coupled between the accessing module and the storing module.

8. The electronic system of claim 5, wherein the swap module is coupled between the accessing module and the calculating module.
